(19) United States
(12) Patent Application Publication
(10) Pub. No.: US 2004/0117824 A1
(43) Pub. Date: Jun. 17, 2004

(54) Method and system for media processing providing access to distributed media via a channel guide

(76) Inventors: Jeyhan Karaoguz, Irvine, CA (US); James Bennett, Laguna Beach, CA (US)

Correspondence Address: MCANDREWS HELD & MALLOY, LTD, 500 WEST MADISON STREET, SUITE 3400, CHICAGO, IL, 60661

(21) Appl. No.: 10/675,382

(22) Filed: Sep. 30, 2003

Related U.S. Application Data
(60) Provisional application No. 60/432,472, filed on Dec. 11, 2002.
(60) Provisional application No. 60/443,894, filed on Jan. 30, 2003.
(60) Provisional application No. 60/457,179, filed on Mar. 25, 2003.
(60) Provisional application No. 60/443,897, filed on Jan. 30, 2003.

(51) Int. Cl. H04N 5/445; G06F 3/00; G06F 13/00

(52) U.S. Cl. 725/39; 725/42; 725/52; 725/55

(57) ABSTRACT

Certain embodiments of the invention for presenting available media for selection and playback on a television display may comprise detecting available media and constructing at least one display indicating the availability of the detected available media at a plurality of different storage locations. An indication of the different storage locations for the detected available media may be presented in the constructed display in a text format, a graphic format and/or an audio format. One or more content categories associated with the detected available media may be identified and the indication of the different storage locations may be associated with one or more of the content categories. Providers of media and/or storage devices at the different storage locations may be queried for available media and the media acquired accordingly. The constructed display may be represented as a graphical user interface (GUI) and displayed on the television screen.

### CROSS-REFERENCE TO RELATED APPLICATIONS/INCORPORATION BY REFERENCE

This application makes reference to, claims priority to, and claims the benefit of:

U.S. Provisional Application Serial No. 60/432,472 (Attorney Docket No. 14185US01 01001P-BP-2800) filed Dec. 11, 2002;

U.S. Provisional Application Serial No. 60/443,894 (Attorney Docket No. 14274US01 01002P-BP-2801) filed Jan. 30, 2003;

U.S. Provisional Application Serial No. 60/457,179 (Attorney Docket No. 14825US01 01015P-BP-2831) filed Mar. 25, 2003; and

U.S. Provisional Application Serial No. 60/443,897 (Attorney Docket No. 14276US01 01004P-BP-2803) filed Jan. 30, 2003.

This application also makes reference to:

U.S. application Ser. No. ______ (Attorney Docket No. 14185US02 01001P-BP-2800) filed Sep. 8, 2003; and

U.S. application Ser. No. ______ (Attorney Docket No. 14274US02 01002P-BP-2801) filed Sep. 11, 2003.

All of the above stated applications are incorporated herein by reference in their entirety.

### FIELD OF THE INVENTION

Certain embodiments of the invention relate to information access. More specifically, certain embodiments of the invention relate to a media processing system for providing access to distributed media via a channel guide.

### BACKGROUND OF THE INVENTION

A personal computer (PC) employing a web browser is often utilized to access media, data, and services distributed over various web sites on the Internet. Also, interactive TV services are sometimes provided by set-top-boxes using a similar kind of browser and, essentially, merely replicate the same web site functionality provided by a PC.

Often, a user is not aware of web sites that are available on the Internet and the type of media and data they might provide. A user typically utilizes a search engine service to look for web sites in order to find media and data that are available on the Internet, which may be of interest to the user. Generalized search engines are typically provided by web portals. Notwithstanding, searching for media and data of interest may be a time-consuming and frustrating exercise, especially if the user is searching for media and data that does not exist and/or is not searchable on the Internet. Furthermore, the search process may be even more frustrating to a user that may not be Internet savvy and who might not be able to create sophisticated search strings.

Also, a PC is often used to access media stored on a media peripheral via a wired link. The accessing of media stored on such media peripherals may involve certain steps. For example, there may be an exchange of media meta information such as media file names, sizes, dates, resolution and format. Additionally, the media may be uploaded to the media peripheral or downloaded from the media peripheral. Accordingly, it may be desirable for a user to extract media for common tasks such as printing, routing, or other processing. Media may be loaded into a device such as a media player for playback or review. Even so, the overall process for doing so may be time consuming and in certain instances, may even be difficult.

For example, in the case of using a digital camera, a user may not remember if any digital pictures are currently stored on the camera, the amount of pictures that are stored, and how many more pictures may be taken before the camera's storage is depleted. As a result, the user may be totally unaware of the current storage state of the digital camera.

The user may remove the digital camera from its case, turn on the power, adjust the camera's settings and capture images. Afterwards, the user turns off the power and returns the camera to its case. Later, having access to a personal computer, the user may remove the digital camera from its case, attach a cable between the PC and the digital camera and power up the digital camera. Subsequent to powering up the camera, the camera may be placed in a download mode and an application may be executed on the personal computer that may cause the images to be copied from the digital camera to the personal computer via the cable. After completion of the download, the user may power down the digital camera, remove the cable, place the camera in its case and exit the PC application. This process is very tedious and time consuming, and, especially when problems arise, requires a fairly savvy user.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

Aspects of the invention may be found in a method and system for presenting available media for selection and playback on a television display. Certain embodiments of the method may comprise detecting available media and constructing at least one display indicating the availability of the detected available media at a plurality of different storage locations. An indication of the plurality of different storage locations for the detected available media may be presented in the constructed display. The presented indication may be in a text format, a graphic format and/or an audio format. Notwithstanding, one or more content categories associated with the detected available media may be identified. The indication of the plurality of different storage locations for the detected available media may be associated with one or more of the content categories.

The method may further include querying providers of media and/or storage devices at the plurality of different storage locations for the available media. The available media may be acquired from at least one of the providers of media and/or a media storage device. In any case, at least one of the constructed displays may be formatted as, for example, a graphical user interface (GUI) and displayed on the television screen. At least a portion of the detected available media at the plurality of different storage locations may be selected for constructing the display.

Another embodiment of the invention may provide a machine-readable storage, having stored thereon, a computer program having at least one code section for presenting available media for selection and playback on a television display. The at least one code section may be executable by a machine, thereby causing the machine to perform the steps as described above for presenting available media for selection and playback on a television display.

Certain embodiments of the system for selection and playback on a television display may comprise at least one processor that detects available media and constructs at least one display indicating the availability of the detected available media at a plurality of different storage locations. The processor may be a computer processor, a media peripheral processor, a media exchange system processor, a media processing system processor or a combination thereof. In any case, an indication of the plurality of different storage locations for the detected available media may be presented by the processor in the constructed display. The presented indication may be in a text format, a graphic format and/or an audio format. Notwithstanding, the processor may identify one or more content categories associated with the detected available media. The indication of the plurality of different storage locations for the detected available media may be associated by the processor with one or more of the content categories.

In another aspect of the invention, the processor may further query providers of media and/or storage devices at the plurality of different storage locations for available media. Accordingly, the processor may acquire available media from at least one of the providers of media and/or a media storage device. In any case, the processor may format at least one of the constructed displays as, for example, a graphical user interface (GUI) and cause it to be displayed on the television screen. At least a portion of the detected available media at the plurality of different storage locations may be selected by the processor for constructing the display.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a diagram illustrating an embodiment of a media exchange network supporting access of stored media in accordance with various aspects of the present invention.

FIG. 1B is a diagram illustrating an embodiment of a device view constructed by associating push/pull media storage devices with stored media content categories within the media exchange network of FIG. 1A in accordance with various aspects of the present invention.

FIG. 1C is a diagram illustrating an embodiment of a media view constructed by associating the media content categories of FIG. 1B with specific media content within the system that supports media communication of FIG. 1A in accordance with various aspects of the present invention.

FIG. 2A is a flowchart illustrating an embodiment of an exemplary method for generating the device view of FIG. 1B and the media view of FIG. 1C by detecting media devices and content in the media exchange network of FIG. 1A, in accordance with various aspects of the present invention.

FIG. 2B is a flowchart illustrating an embodiment of an exemplary method for retrieving a media content category from the device view of FIG. 1B using the media exchange network of FIG. 1A, in accordance with various aspects of the present invention.

FIG. 2C is a flowchart illustrating an embodiment of an exemplary method for retrieving media content from the media view of FIG. 1C using the media exchange network of FIG. 1A, in accordance with various aspects of the present invention.

FIGS. 3 is a schematic block diagram of a first exemplary media exchange network in accordance with an embodiment of the present invention.

FIG. 4 is a schematic block diagram of performing personal media exchange over a second exemplary media exchange network in accordance with an embodiment of the present invention.

FIG. 5 is a schematic block diagram of performing third-party media exchange over a third exemplary media exchange network in accordance with an embodiment of the present invention.

FIG. 6 is an exemplary illustration of a TV guide channel user interface in accordance with an embodiment of the present invention.

FIG. 7 is an exemplary illustration of several instantiations of a TV guide channel user interface of FIG. 4 in accordance with an embodiment of the present invention.

FIG. 8 is an exemplary illustration of a TV guide channel user interface showing several options of a pushed media in accordance with an embodiment of the present invention.

FIG. 9A is a schematic block diagram of a media processing system (MPS) interfacing to media capture peripherals in accordance with an embodiment of the present invention.

FIG. 9B illustrates an alternative embodiment of a media processing system (MPS) in accordance with various aspects of the present invention.

FIG. 10 is a schematic block diagram of a PC and an MPS interfacing to a server on a media exchange network in accordance with an embodiment of the present invention.

FIG. 11 is a schematic block diagram of a PC interfacing to personal media capture devices and remote media storage on a media exchange network in accordance with an embodiment of the present invention.

### DETAILED DESCRIPTION OF THE INVENTION

Aspects of the invention relate to the access of distributed media on a media exchange network by a media processing system. In particular, certain embodiments of the invention may relate to detecting devices on a media exchange network and associating stored media content with the detected devices and/or with various media content categories. Accordingly, aspects of the invention may also provide means for viewing the associations in a format that may more readily allow a user to understand the various media available on the media exchange network.

Aspects of the invention may also be found in a method and system for presenting available media for selection and playback on a television display. Certain embodiments of the method for presenting available media for selection and playback on a television display may comprise detecting available media and constructing at least one display indicating the availability of the detected available media at a plurality of different storage locations. An indication of the different storage locations for the detected available media may be presented in the constructed display in a text format, a graphic format and/or an audio format. One more content categories associated with the detected available media may be identified and the indication of the different storage locations may be associated with one or more of the content categories.

Providers of media and/or storage devices at the different storage locations may be queried for available media. The available media may be acquired from at least one of the providers of media and/or a media storage device. In any case, at least one of the constructed displays may be formatted as, for example, a graphical user interface (GUI) and displayed on the television screen. At least a portion of the detected available media at the plurality of different storage locations may be selected for constructing the display.

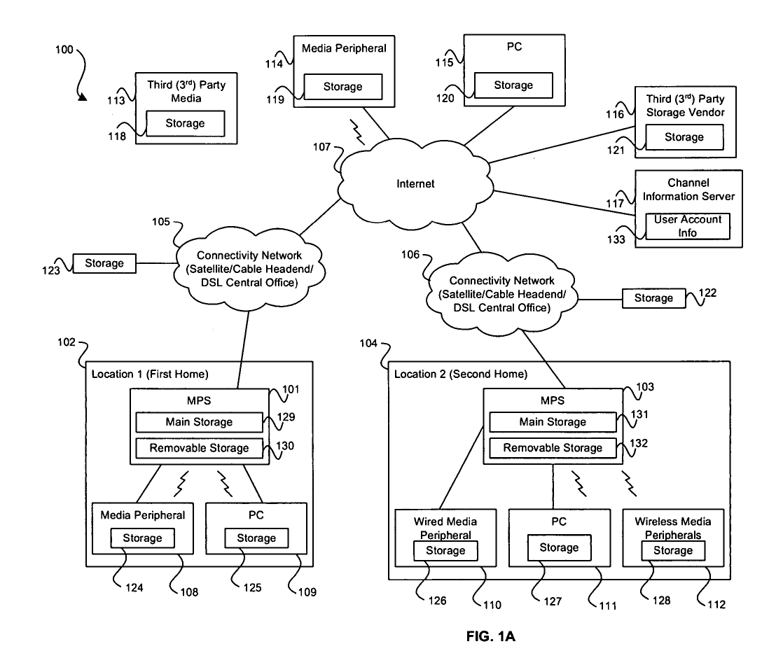

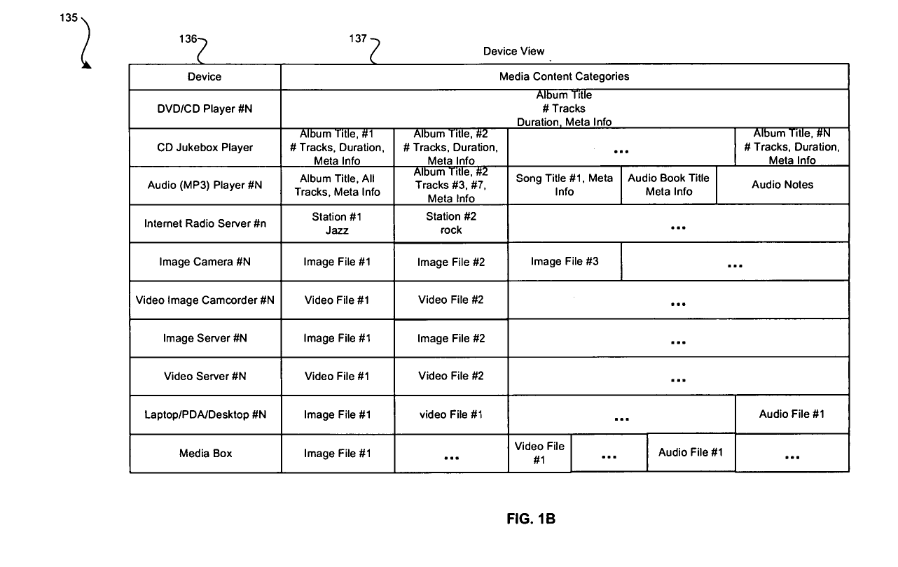

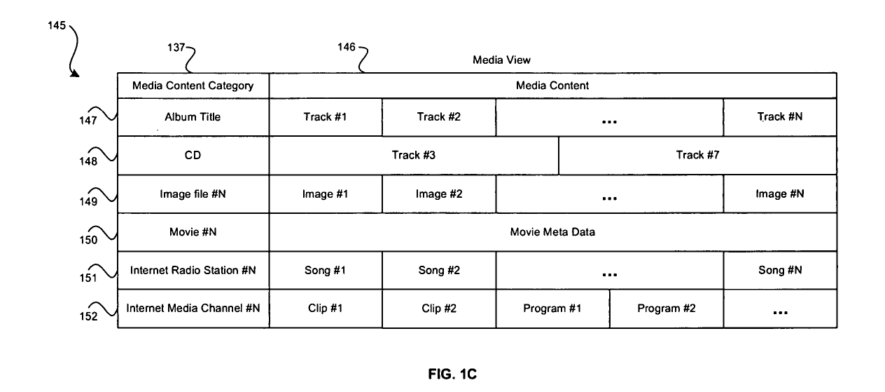

FIG. 1A is a diagram illustrating an embodiment of a media exchange network supporting access of stored media in accordance with various aspects of the present invention. Referring to FIG. 1A, there is shown a network or system that supports media communication may include a first media processing system (MPS) 101 situated at a first location such as a first home 102. A second media processing system 103 may be situated at a second location such as a second home 104. The media exchange network may also include a first connectivity network 105, a second connectivity network 106 and an Internet infrastructure 107. The first media processing system 101 may interface with the first connectivity network 105 and the second media processing system 103 may interface with the second connectivity network 106. Both connectivity networks 105 and 106 may interface with the Internet infrastructure 107. The network or system that supports media communication may also be referred to as a media exchange network 100.

A media processing system may also comprise a set-top-box (STB), a PC, and/or a television with a media management system (MMS). A media management system may also be referred to as a media exchange software (MES) platform. Notwithstanding, a media management system may include a software platform operating on at least one processor that may provide certain functionality including user interface functionality, distributed storage functionality, networking functionality, and automatic control and monitoring of media peripheral devices. For example, a media management system may provide automatic control of media peripheral devices, automatic status monitoring of media peripheral devices, and inter-home media processing system routing selection. A media processing system may also be referred to as a media-box and/or an M-box. Any personal computer may indirectly access and/or control any media peripheral device in instances where the personal computer may include a media management system. Such access and/or control may be accomplished through various communication pathways via the media processing system or outside of the media processing system. A media processing system may also have the capability to automatically access and control any media peripheral device without user interaction and/or with user intervention. A personal computer (PC) may include media exchange software running on or being executed by the personal computer and may be referred to as a media processing system. The media processing system may also include a speech recognition engine that may be adapted to receive input speech and utilize the input speech control various functions of the media processing system.

Each of the elements or components of the network for communicating media or media exchange network may be identified by a network protocol address or other identifier which may include, but is not limited to, an Internet protocol (IP) address, a media access control (MAC) address and an electronic serial number (ESN). Examples of elements or components that may be identified by such addresses or identifiers may include media processing systems, media management systems, personal computers, media or content providers, media exchange software platforms and media peripherals.

The system that supports media communication 100 may also include a media peripheral 108 and a PC 109 both interfacing, via a wired and/or wireless connection, to the media processing system 101. The system that supports media communication 100 may further include wired media peripherals 110 interfacing to the media processing system 103 via wired connections, PC 111 interfacing to the media processing system 103 via a wired or wireless connection, and wireless media peripherals 112 interfacing to media processing system 103 via wireless connections.

The system that supports media communication 100 may further include a plurality of other systems that may interface with the Internet infrastructure 107. These systems may include a third (3^{rd}) party media provider 113, a media peripheral 114, a PC 115, a third (3^{rd}) party storage vendor 116, and a channel information server 117. Various network system components of the system that supports media communication 100 may include storage locations for digital media and data. The third (3^{rd}) party media provider 113 may include a storage location 118. The media peripheral 114 may include a storage location 119 and the PC 115 may include a storage location 120. The third (3rd) party storage vendor 116 may include a storage location 121. The first connectivity network 105 may include a storage location 123 and the second connectivity network 106 may include a storage location 122. The media peripheral 108 may include a storage location 124, the PC 109 may include a storage location 125 and the PC 111 may include a storage location 127. Finally, the wired media peripherals 110 may include a storage location 126 and the wireless media peripherals 112 may also include a storage location 128.

The first media processing system 101 may include a main storage location 129 and a removable storage location 130. Furthermore, the second media processing system 103 may include a main storage location 131 and a removable storage location 132. The channel information server 117 may be utilized to store user account information 133, for example. The main storage locations may include, for example, hard disk drives, a DVD player, a CD player, floppy disk drives, RAM, or any combination thereof. The removable storage locations may include, for example, memory sticks, PCM/CIA cards, compact flash cards, microdrives, secure digital cards or any combination thereof. The PC's may include desktop PC's, notebook PC's, PDA's, or any computing device.

The various media peripherals 108, 110, 112, 114 of the system that supports media communication 100 may include, for example, a digital camera, a digital camcorder, a MP3 player, a WMA, a home juke-box system, a personal digital assistant (PDA) and a multi-media gateway device. The media processing systems 101, 102 may include a TV screen or monitor for viewing a list of devices and media content that may be available on the media exchange network. The connectivity networks 105, 106 may include, for example, a satellite network with a satellite headend, a cable network with a cable headend, and/or a xDSL infrastructure within a central office.

In accordance with an embodiment of the invention, the media processing systems 101, 103 may be adapted to detect the various devices that may be coupled to or otherwise connected to the system that supports media communication 100. The media processing systems 101, 103 may identify the media content stored in those devices and associate the media content with the devices and media content categories.

FIG. 1B is a diagram illustrating an embodiment of a device view 135 constructed by associating push/pull media storage devices 136 with stored media content categories 137 within the system that supports media communication 100 of FIG. 1A in accordance with various aspects of the present invention. The device view 135 may be constructed by the media processing system 101 and/or the media processing system 103. For example, the media processing system 101 may search the system that supports media communication 100 and find or locate the following push/pull media storage devices:

a media peripheral 108 comprising, for example, a DVD/CD player #N;

one of the wired media peripherals 110 including, for example, a CD Jukebox player;

one of the wireless media peripherals 112 including, for example, an audio (MP3) player #N;

channel information server 117 including, for example, an Internet radio server #N;

media peripheral 114 including, for example, an image camera #N;

one of the wireless media peripherals 112 including, for example, a video/image camcorder #N;

third (3rd) party media provider 113 including, for example, an image server #N;

third (3rd) party storage vendor 116 including, for example, a video server #N;

one of the wired media peripherals 110 including, for example, a laptop/PDA/desktop #N; and

media processing system 103 including, for example, a media box.

The media processing system 101 may also identify and associate media content categories 137 with the detected media storage devices. The following illustrates exemplary media content and media storage device associations:

DVD/CD player #N may be associated with media content categories including an album title having #tracks, duration of tracks, and meta info;

CD Jukebox player may be associated with media content categories including Album title #1 to Album title #N;

audio (MP3) player #N may be associated with media content categories including Album title #1, Album title #2, Song title #1, audio book title, and audio notes;

Internet Radio Server #N may be associated with media content categories including Station #1 (Jazz), Station #2 (Rock);

Image Camera #N may be associated with media content categories comprising Image file #1, Image file #2, Image file #3;

Video/Image camcorder #N may be associated with media content categories comprising Video file #1, Video file #2;

Image Server #N may be associated with media content categories including Image file #1, Image file #2;

Video server #N may be associated with media content categories including Video file #1, Video file #2;

Laptop/PDA/Desktop #N may be associated with media content categories including Image file #1, Video file #1, Audio file #1; and

Media box may be associated with media content categories including Image file #1, etc., Video file #1, etc., Audio file #1.

The media processing system 101, after generating or creating the associations, may construct or generate a device view 135, having a format illustrating device versus media content categories as shown in FIG. 1B. Accordingly, generated device view 135 may be displayed to a user of the media processing system 101.

FIG. 1C is a diagram illustrating an embodiment of a media view 145 constructed by associating the media content categories 137 of FIG. 1B with specific media content 146 within the system that supports media communication 100 of FIG. 1A in accordance with various aspects of the present invention. For example, the media processing system 103 may search the media exchange network 100 and locate the following media content categories 137:

album title 147 stored on media peripheral 114;

CD 148 stored on third (3rd) party storage vendor 121;

Image file #N 149 stored on media peripheral 108;

Movie #N 150 stored on third (3rd) party media provider 113;

Internet radio station #N 151 stored on third (3rd) party media provider 113; and

Internet media channel #N 152 stored on channel information server 117.

The media processing system 103 may also identify and associate specific media content 146 with the media content categories. For example:

Album title 147 may be associated with media content comprising Tracks #1 to #N;

CD 148 may be associated with media content comprising Track #3 and Track #7;

Image file #N 149 may be associated with media content comprising Images #1 to #N;

Movie #N 150 may be associated with media content comprising movie meta data;

Internet radio station #N 151 maybe associated with media content comprising Songs #1 to #N; and

Internet media channel #N 152 may be associated with media content comprising Clip #1 to #2, and program #1 to #2.

The media processing system 103, after forming or generating the associations, may construct the media view 145, having a format illustrating media content category 137 versus media content 146 as shown in FIG. 1C. The media view 145 may be displayed to a user of the media processing system 103.

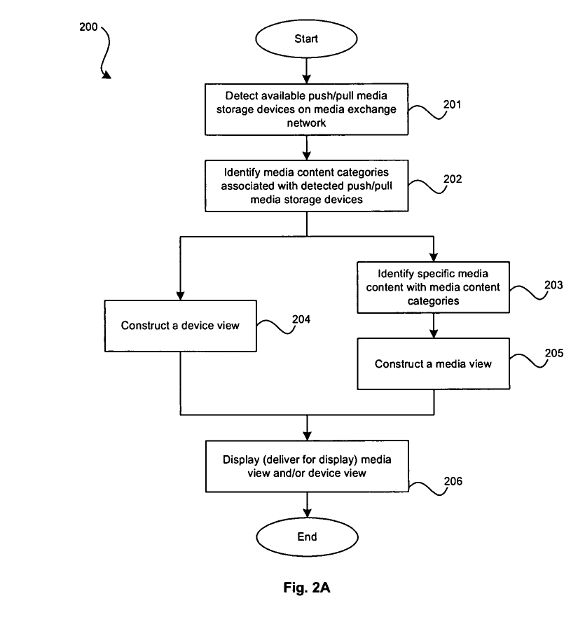

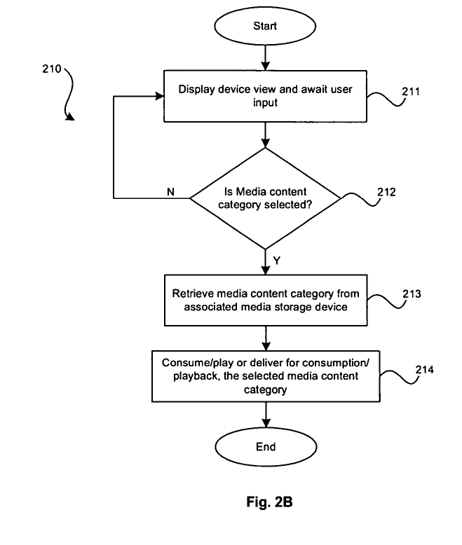

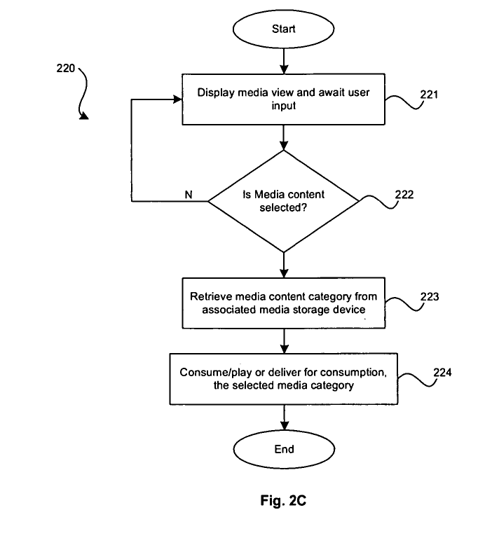

FIG. 2A is a flowchart illustrating an embodiment of an exemplary method 200 for generating the device view of FIG. 1B and the media view of FIG. 1C by detecting media devices and content in the media exchange network of FIG. 1A, in accordance with various aspects of the present invention.

In step 201, push/pull media storage devices that are available on the system that supports media communication 100 may be detected by, for example, the media processing system 101. In step 202, the media content categories associated with the detected push/pull media storage devices may be identified by, for example, the media processing system 101. Accordingly, the method 200 may branch into two paths, a first path for the device view (steps 204 and 206) and a second path for the media view (steps 203, 205 and 206).

In step, 203, specific media content associated with the media content categories may be identified by, for example, media processing system 101. In step 204, a device view may be constructed or generated by, for example MPS 101, having a format illustrating device versus media content category. In step 205, a media view may be constructed or generated by, for example, media processing system 101, having a format illustrating media content category versus specific media content. In step 206, the media view and/or display view may be displayed to a user by, for example, media processing system 101 or delivered for display by, for example, the media processing system 101 to another device on the system that supports media communication 100 such as media processing system 103. In an alternative embodiment of the invention, the method 200 may be split into two separate methods, one for the device view and one for the media view. As a result, only a device view may be created or only a media view may be created.

In accordance with an embodiment of the invention, a media processing system may continuously or periodically search a media exchange network, form associations, and update the device view and/or media view based on those associations. Also, searching may be done based on user authorization. For example, a user may be provided with the capability of choosing to exclude certain third (3rd) party media on the media exchange network, thereby allowing only certain types of third (3rd) party media to be incorporated into the device view and/or media view. For example, adult content may be totally excluded or it may be restricted based on certain criteria. In another example, infomercials may be blocked but other types of media may be allowed.

In accordance with an embodiment of the invention, if a media peripheral comes within proximity or a certain range of a media processing system, the media processing system may detect the presence of the media peripheral and add its media content categories to the device view, or add its media content to the media view. For example, a user, after taking pictures with his digital camera in the woods, may return home with the digital camera. Once the digital camera is within a certain range of the user's media processing system, a wireless link may be automatically established between the media processing system and the digital camera. Accordingly, the recently taken digital pictures may be incorporated into the device view and/or media view by the media processing system. In another aspect of the invention, these pictures may be downloaded to other appliances or devices within the home or at another location. For example, the user's mother's media processing system's media view may be automatically updated with the recently taken digital pictures. In another example, the recently taken pictures may be automatically transferred to the local nature lover's web server or website via the media processing system.

FIG. 2B is a flowchart illustrating an embodiment of an exemplary method 210 for retrieving a media content category from the device view 135 of FIG. 1B using the system that supports media communication 100 of FIG. 1A, in accordance with various aspects of the present invention. Referring to FIG. 2B, in step 211, the device view 135 may be displayed by, for example, the media processing system 101, which may await a user input. In this regard, in step 212, the media processing system 101 may constantly or periodically poll and determine when a user selects a media content category from the device view. If no media content category selection is made, the steps 211 and 212 are repeatedly executed in a loop. However, if a media content category is selected, then step 213 may be executed. In step 213, the selected media content category may be retrieved from the associated media storage device by, for example, the media processing system 101. For example, a user may select “Station #1 (Jazz)” from the Internet Radio Server #N from device view 135 as illustrated in FIG. 1B. Accordingly, all of the songs media content such as the songs associated with “Station #1 (Jazz)” may be downloaded to, for example, the main storage area 129 of MPS 101. Referring to step 213, all the media content associated with the media content category may be retrieved. However, the invention is not limited in this regard, and in certain instances, only media content matching a specified criteria may be retrieved. This may save on bandwidth consumption.

In step 214, the retrieved media content category may be consumed/played for a user by, for example, the media processing system 101, or delivered to another device on the system that supports media communication 100. In this regard, the media may be delivered to the media processing system 103 for later consumption/playback such as viewing and/or listening.

FIG. 2C is a flowchart illustrating an embodiment of an exemplary method 220 for retrieving media content from the media view 145 of FIG. 1C using the system that supports media communication or media exchange network 100 of FIG. 1A, in accordance with various aspects of the present invention.

Referring to FIG. 2C, in step 221, the media view 145 may be displayed by, for example, the media processing system 103, which may await a user input. In this regard, in step 222, the media processing system 103 may constantly or periodically poll and determine when a user selects a particular media content from the media view. If no media content is selected from the media view, steps 221 and 222 are repeatedly executed in a loop. However if media content is selected, then step 223 is executed. In step 223, the media content may be retrieved from the associated media storage device. In this regard, the media processing system 103 may retrieve the media content form the associate media storage device. For example, a user may select “Track #3” from the CD from media view 145 as shown in FIG. 1C.

In step 224, the retrieved media content may be consumed/played for a user by, for example, the media processing system 103. The retrieved media content may also be delivered to another device on the system that supports media communication 100 or media exchange network 100 such as the media processing system 101 for later consumption or playback. With reference to the example of step 223, “Track #3” may be subsequently consumed or played.

In accordance with an embodiment of the invention, media content may be downloaded to a user's home at the time of construction or updating of a media view and/or device view. However, the download may be dependent on factors such as the availability of sufficient bandwidth and sufficient storage capacity at the user's home to accomplish download of the media content. Alternatively, media content may be downloaded only when a user specifically selects media content on a media view, or selects a media content category on a device view. Notwithstanding, certain media content may be subject to restricted download or to a total download prohibition for the device view update and/or media view update.

An embodiment of the invention may provide a method making information available and accessible in a distributed media network. The method may comprise the step of detecting the availability of media in a media exchange network. Once the media is detected, a device view and/or a media view may be constructed by utilizing the detected available media. At least one media content category associated with the available media may further be identified. Also, at least one media content may be identified within the media content category. The method may also include generating a device view from the identified media content category. A media view may also be generated based on the media content category and/or the identified media content.

The constructed device view and/or a media view may be formatted and presented in a graphical user interface. At least a portion of the available media may be selected and utilized to construct the device view and/or the media view. Although media content providers and/or media storage devices may be polled for the available media, the media may otherwise be acquired from a media content provider and/or a media storage device. For example, media may be made readily accessible once a device having the media is coupled or otherwise connected to the distributed media network.

A major challenge is to be able to transfer and share many different types of digital media, data, and services between one device/location and another with ease while being able to index, manage, and store the digital media and data.

For example, it is desirable to be able to distribute and store many types of digital media in a PC and/or television environment in a user-friendly manner without requiring many different types of software applications and/or unique and dedicated interfaces. Any networking issues or other technical issues should be transparent to the users. It is also desirable to take advantage of existing hardware infrastructure, as much as possible, when providing such capability.

In an embodiment of the present invention, a media exchange network is provided that enables many types of digital media, data, and/or services to be stored, indexed, viewed, searched for, pushed from one user to another, and requested by users, using a media guide user interface. The media exchange network also allows a user to construct personal media channels that comprise his personal digital media (e.g., captured digital pictures, digital video, digital audio, etc.), request that third-party media channels be constructed from third-party digital media, and access the media channels pushed to him by other users on the media exchange network.

PC's may be used but are not required to interface to the media exchange network for the purpose of exchanging digital media, data, and services. Instead, set-top-boxes or integrated MPS's (media processing systems) may be used with the media exchange network to perform all of the previously described media exchange functions using a remote control with a television screen.

Current set-top-boxes may be software enhanced to create a MPS that provides full media exchange network interfacing and functionality via a TV screen with a TV guide look-and-feel. PC's may be software enhanced as well and provide the same TV guide look-and-feel therefore, the media exchange network supports both PC's and MPS's in a similar manner. Alternatively, a fully integrated MPS may be designed from the ground up, having full MPS capability.

In the case of an MPS configuration, the user takes advantage of his remote control and TV screen to use the media exchange network. In the case of a PC configuration, the user takes advantage of his keyboard and/or mouse to use the media exchange network.

An MPS or enhanced PC is effectively a storage and distribution platform for the exchange of personal and third party digital media, data, and services as well as for bringing the conventional television channels to a user's home. An MPS and/or PC connects to the media exchange network via an existing communication infrastructure which may include cable, DSL, satellite, etc. The connection to the communication infrastructure may be hard-wired or wireless.

The media exchange network allows users to effectively become their own broadcasters from their own homes by creating their own media channels and pushing those media channels to other authorized users on the media exchange network, such as friends and family members.

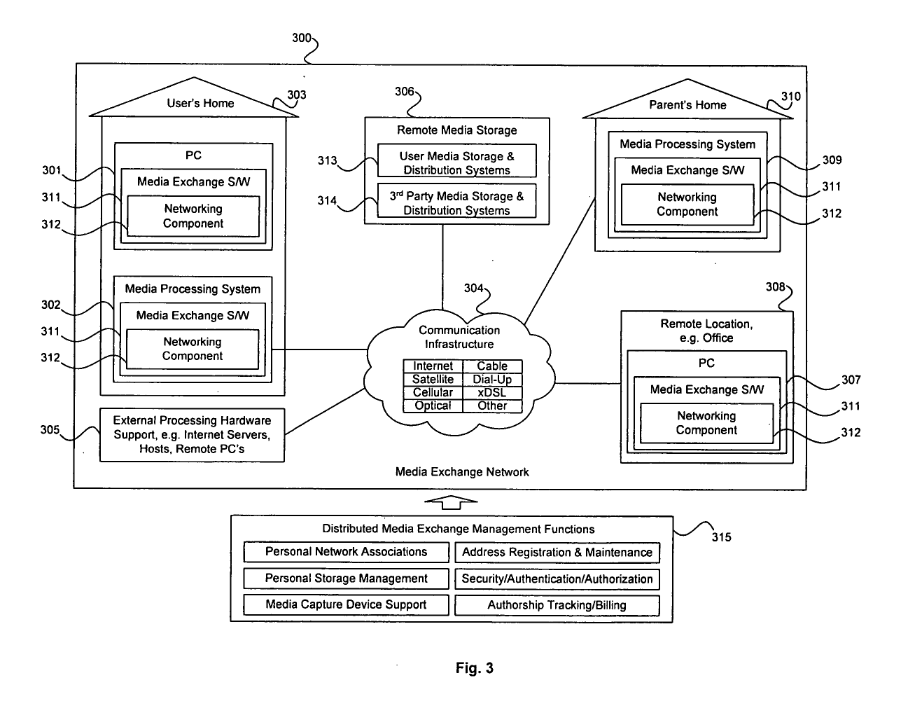

FIG. 3 comprises a media exchange network 300 for exchanging and sharing digital media, data, and services in accordance with an embodiment of the present invention. The media exchange network 300 is a secure, closed network environment that is only accessible to pre-defined users and service providers. The media exchange network of FIG. 3 comprises a first PC 301 and a first media processing system (MPS) 302 at a user's home 303, a communication infrastructure 304, external processing hardware support 305, remote media storage 306, a second PC 307 at a remote location 308 such as an office, and a second MPS 309 at a parent's home 310.

The PC's 301 and 307 and the MPS's 302 and 309 each include a media exchange software (MES) platform 311 and a networking component 312 for connectivity. The MES platform 311 provides multiple capabilities including media “push” capability, media “access” capability, media channel construction/selection, image sequence selection, text and voice overlay, channel and program naming, interhome routing selection, authorship and media rights management, shared inter-home media experience, billing service, and an integrated media guide interface providing a TV channel guide look-and-feel.

The external processing hardware support 305 comprises at least one server such as a centralized internet server, a peer-to-peer server, or cable head end. The server may alternatively be distributed over various hosts or remote PC's. The MES platform 311 may also reside on the external processing hardware support server 305. The remote media storage 306 may comprise user media storage and distribution systems 313 and/or third party media storage and distribution systems 314.

The communication infrastructure 304 may comprise at least one of internet infrastructure, satellite infrastructure, cable infrastructure, dial-up infrastructure, cellular infrastructure, xDSL infrastructure, optical infrastructure, or some other infrastructure. The communication infrastructure 304 links the user's home 303, parent's home 310, remote media storage 306, and remote location office 308 to each other (i.e., the communication infrastructure 304 links all users and service providers of the media exchange network 300).

The various functions 315 of the media exchange network 300 comprise generating personal network associations, personal storage management, media capture device support, security/authentication/authorization support, authorship tracking and billing and address registration and maintenance. These media exchange management functions 315 may be distributed over various parts of the media exchange network 300. For example, the personal network associations and personal storage management functions may be integrated in the PC 301 at the user's home 303.

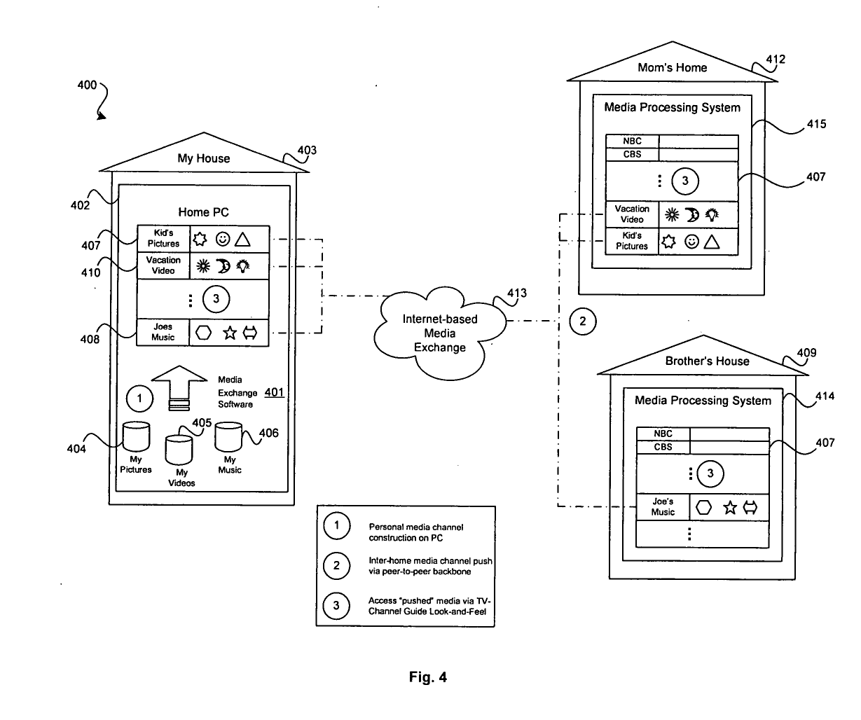

FIG. 4 illustrates an example of personal media exchange over a media exchange network 400 in accordance with an embodiment of the present invention. In step 1, the media exchange software (MES) platform 401 is used to construct personal media channels on a PC 402 by a user at “my house” 403. For example, with various media stored on the PC 402 such as digital pictures 404, videos 405, and music 406, the MES platform 401 allows the digital media to be organized by a user into several channels having a media guide user interface 407 on the PC 402.

In step 2, the user at “my house” 403 pushes a media channel 408 (e.g., “Joe's Music”) to “brother's house” 409 and pushes two media channels 410 and 411 (e.g., “Vacation Video” and “Kid's Pictures”) to “Mom's house” 412 via a peer-to-peer server 413 over the internet-based media exchange network 400. “Brother's house” 409 includes a first MPS 414 connected to the media exchange network 400. “Mom's house” 412 includes a second MPS 415 connected to the media exchange network 400. The MPS's 414 and 415 also provide a media guide user interface 407.

In step 3, brother and/or Mom access the pushed media channels via their respective media processing systems (MPS's) 414 and 415 using their respective MPS TV screens and remote controls.

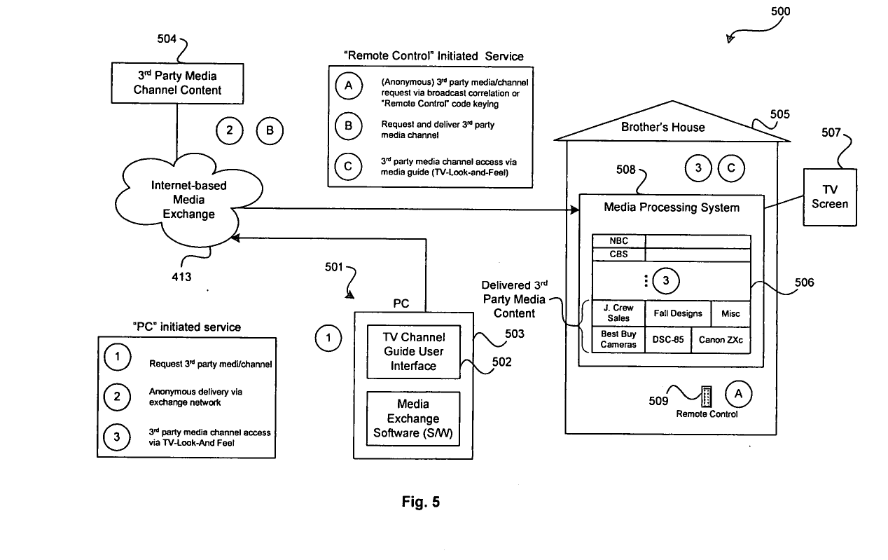

FIG. 5 illustrates an example of third-party media exchange over a media exchange network 500 in accordance with an embodiment of the present invention. In step 1, a PC-initiated third-party request is made by a first party 501 via an internet-based media exchange network 500 using a media guide user interface 502 on a PC 503. In step 2, an anonymous delivery of the requested third-party channel 504 is made to a second party 505 via the internet-based media exchange network 500. In step 3, the second party 505 accesses the third-party channel 504 using a media guide user interface 506 on a TV screen 507 that is integrated into an MPS 508.

Similarly, in step A, an MPS-initiated third-party request is made by a second party 505 via an internet-based media exchange network 500 using a media guide user interface 506 on a TV screen 507 using a remote control 509. The second party 505 may key in a code, using his remote control 509, that is correlated to a commercial or some other third party broadcast media. In step B, an anonymous delivery of the requested third-party channel 504 is made to a first party 501 via the internet-based media exchange network 500. In step C, the first party 501 accesses the third-party channel 504 using a media guide user interface 502 on a PC 503.

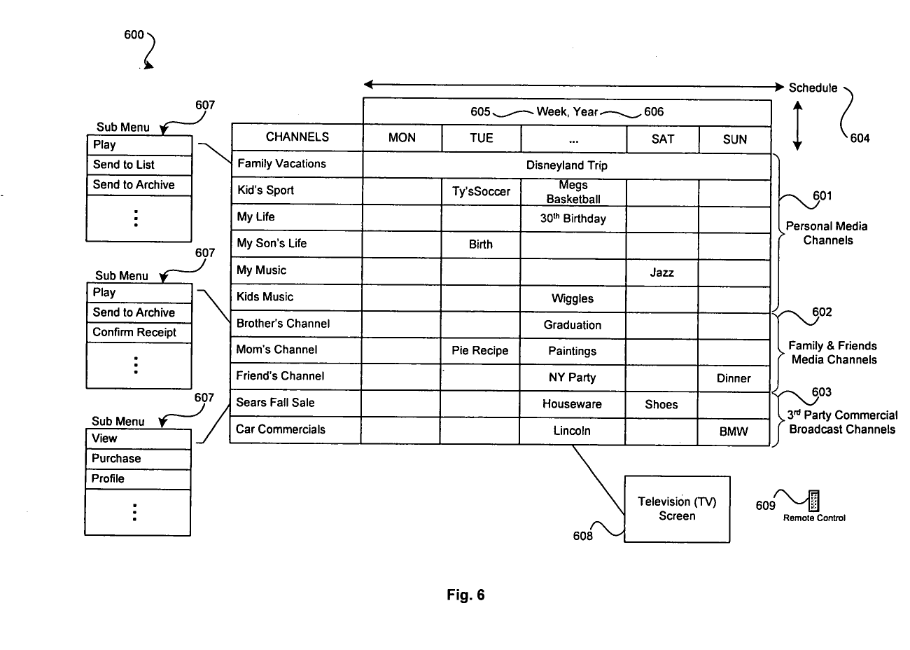

FIG. 6 illustrates a media guide user interface 600 in accordance with an embodiment of the present invention. The media guide user interface 600 may be displayed on a TV screen 608 and controlled by a remote control device 609. Also, the media guide user interface 600 may be displayed on a PC monitor and controlled by a keyboard or mouse.

The media guide user interface 600 may be configured not only for conventional TV channels but also for personal media channels 601 that are constructed by a user of a media exchange network, friend's and family's media channels 602 constructed by friends and family, and third party channels 603 that are constructed by third parties either upon request by a user of a media exchange network or based on a profile of a user.

The personal media channels 601 may include, for example, a “family vacations channel”, a “kid's sports channel”, a “my life channel”, a “son's life channel”, a “my music channel”, and a “kid's music channel”. The friends and family media channels 602 may include, for example, a “brother's channel”, a “Mom's channel”, and a “friend's channel”. The third party media channels 603 may include, for example, a “Sears Fall sale channel” and a “car commercials channel”.

Each media channel may correspond to a schedule 604 showing, for example, a week 605 and a year 606. For example, under the “kid's sports channel”, Ty's soccer game could be scheduled to be viewed on Tuesday of the current week 605 and current year 606. For each media channel, a sub-menu 607 allows for selection of certain control and access functions such as “play”, “send to list”, “send to archive”, “confirm receipt”, “view”, “purchase”, and “profile”.

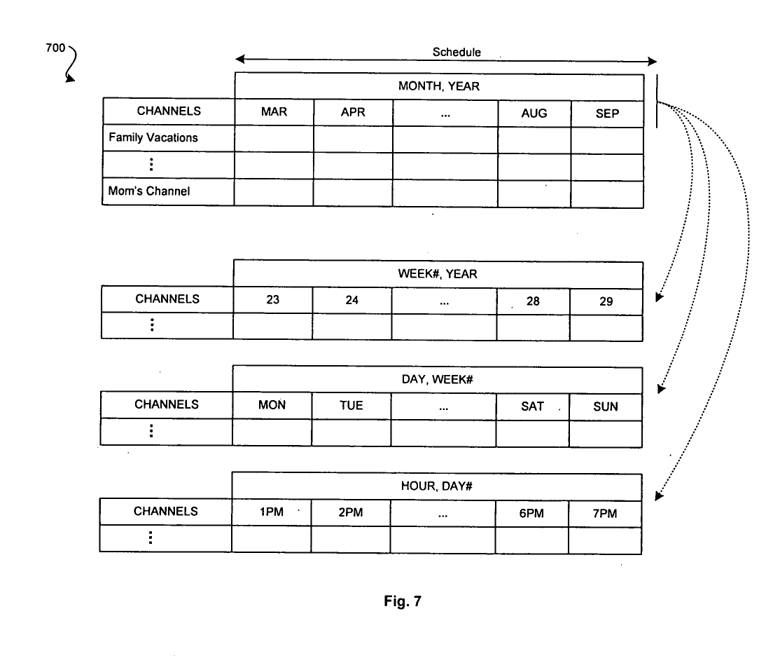

FIG. 7 illustrates possible multiple instantiations of a media guide user interface 700 in accordance with an embodiment of the present invention. The media guide user interface 700 may be viewed with a schedule having formats of, for example, “month, year”, “week#, year”, “day, week#”, or “hour, day”.

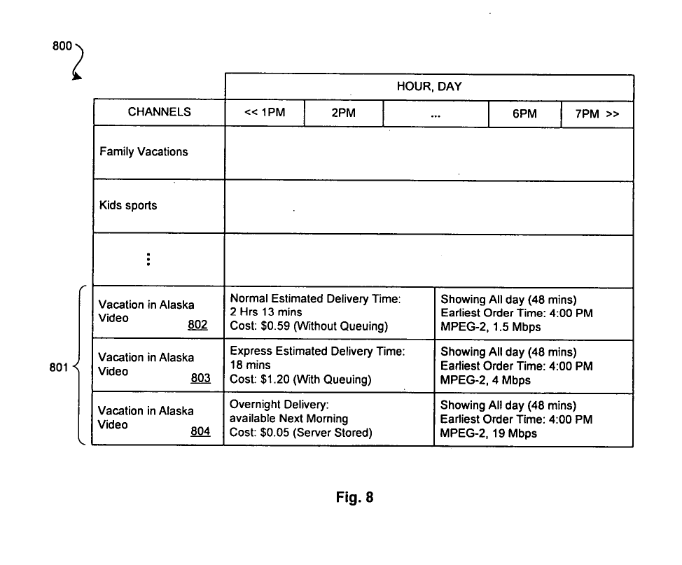

Referring to FIG. 8, a user of a media exchange network may push a media channel (e.g., “Vacation in Alaska Video”) to a friend who is on the same media exchange network. The media guide user interface 800 may give the friend several options 801 for how to accept and download the pushed media in accordance with an embodiment of the present invention.

For example, a first, most expensive option 803 may be “Express Delivery” which would deliver the pushed media to the friend in 18 minutes using queuing and cost $1.20, for example. The pushed media may be stored in a file in an MPEG 2 format that was recorded at a rate of 4 Mbps, for example. Queuing comprises buffering and delivering a previous part of the media and then buffering and delivering a next part of the media. For example, a first six minutes of the “Vacation in Alaska Video” may be buffered and delivered first, then a second six minutes may be buffered and delivered next, and so on until the entire media is delivered.

A second, less expensive option 802 may be “Normal Delivery” which would deliver the pushed media in 2 hours and 13 minutes without queuing and cost $0.59, for example. The pushed media may be stored in a file in an MPEG 2 format that was recorded at a rate of 1.5 Mbps, for example.

A third, least expensive option 804 may be “Overnight Delivery” which would deliver the pushed media by the next morning and cost only $0.05, for example. The pushed media may be stored in a file in an MPEG 2 format that was recorded at a rate of 19 Mbps and stored on a server, for example.

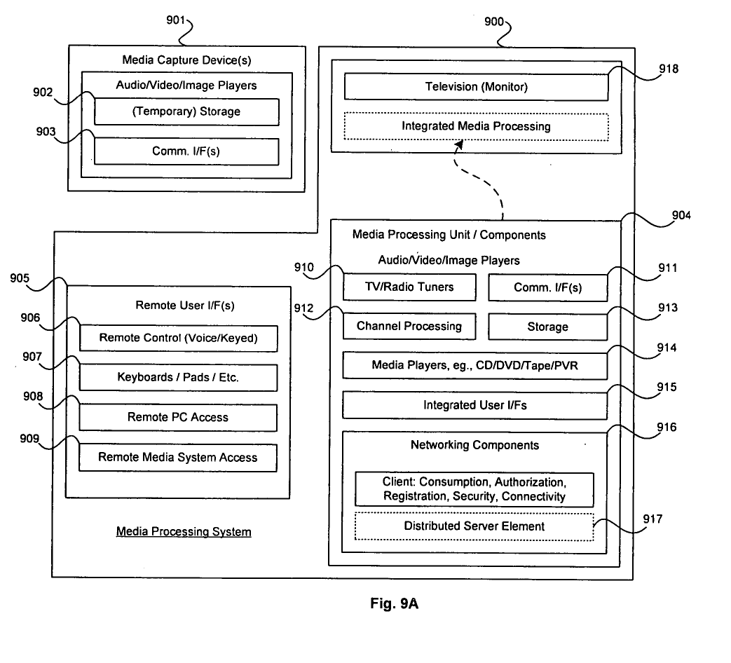

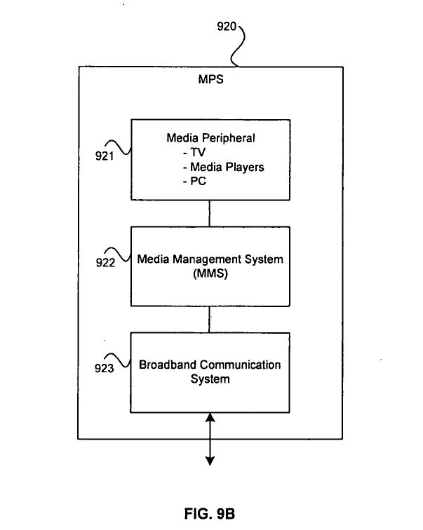

FIG. 9A illustrates the detailed elements of a media processing system (MPS) 900 and media capture devices 901 in accordance with an embodiment of the present invention. The media capture devices 901 may comprise audio, video, and image players, such as digital cameras, digital camcorders, and MP3 players, that each include a temporary storage area 902 and a communication interface 903 such as, for example, a USB interface or a wireless interface. The media capture devices 901 have the capability to interface to an MPS and a PC.

The MPS 900 comprises a media processing unit (MPU) 904, remote user interface(s) 905, and a TV screen 918 to provide integrated media processing capability and indirect user interface capability. The remote user interfaces 905 may comprise a voice or keyed remote control 906, keyboards and pads 907, a remote PC access interface 908, and a remote media system access interface 909 (i.e., providing access from another MPS).

The media processing unit (MPU) 904 comprises TV and radio tuners 910 for image and audio consumption, communications interfaces 911, channel processing 912 (creating, storing, indexing, viewing), storage 913, media players 914 (CD, DVD, Tape, PVR, MP3), an integrated user interface 915 (to provide a TV channel guide look-and-feel), networking components 916 to provide client functions such as consumption (billing), authorization (e.g., using digital certificates and digital ID's), registration, security, and connectivity. In an alternative embodiment of the present invention, the networking components 916 may include a distributed server element 917 that is part of a distributed server.

FIG. 9B illustrates an alternative embodiment of a media processing system (MPS) 920 in accordance with various aspects of the present invention. The MPS 920 is essentially an enhanced set-top-box for viewing and interacting with various user interfaces, media, data, and services that are available on the media exchange network using, for example, a remote control. The MPS 920 comprises a media peripheral 921, a MMS (media management system) 922, and a broadband communication interface 923.

The media peripheral 921 may include a TV (television), a PC (personal computer), and media players (e.g., a CD player, a DVD player, a tape player, and a MP3 player) for video, image, and audio consumption of broadcast and/or personal channels. The broadband communication interface 923 may include internal modems (e.g., a cable modem or DSL modem) or other interface devices in order to communicate with, for example, a cable or satellite headend.

The MMS 922 includes a software platform to provide functionality including media “push” capability, media “access” capability, media channel construction/selection, image sequence selection, text and voice overlay, channel and program naming, inter-home routing selection, authorship and media rights management, shared inter-home media experience, billing service, and a media guide user interface providing an integrated TV channel guide look-and-feel.

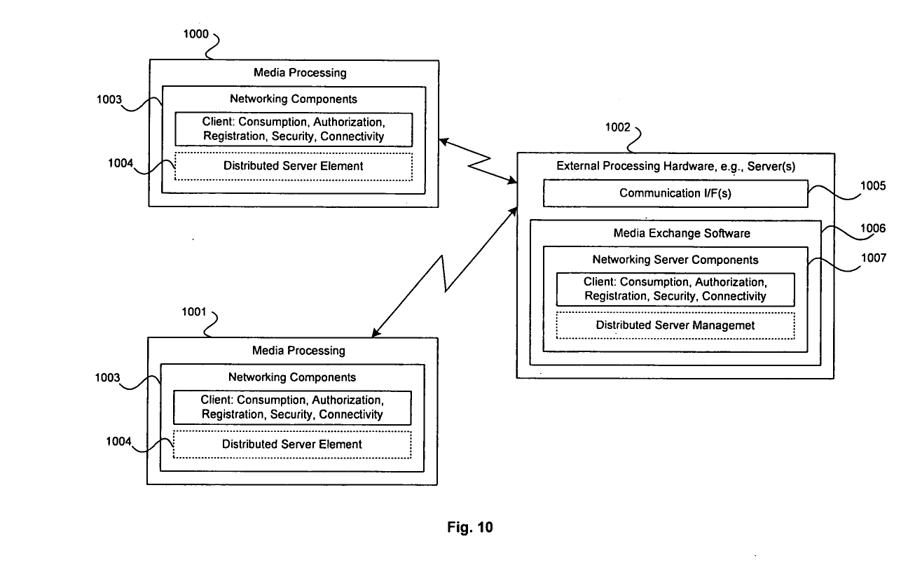

FIG. 10 illustrates connectivity between a PC 1000, an MPS 1001, and external processing hardware 1002 (e.g., a server) in accordance with an embodiment of the present invention. The PC 1000 and MPS 1001 include networking components 1003 to provide client functions such as consumption (billing), authorization, registration, security, and connectivity. Alternatively, the PC 1000 and MPS 1001 may include a distributed server element 1004 that is part of a distributed server.

The PC 1000 and MPS 1001 connect to the external processing hardware 1002 via wired or wireless connections. The external processing hardware 1002 comprises a distributed server or peer-to-peer server. The external processing hardware 1002 also comprises communication interfaces 1005 (e.g., cable interfaces, optical interfaces, etc.) and a media exchange software (MES) platform 1006. The MES platform 1006 in the external processing hardware 1002 allows for communication with the PC 1000 and MPS 1001 which may also use the same MES platform 1006. The external processing hardware 1002 also includes networking server components 1007 to provide the similar client functions such as consumption (billing), authorization, registration, security, and connectivity at the server side.

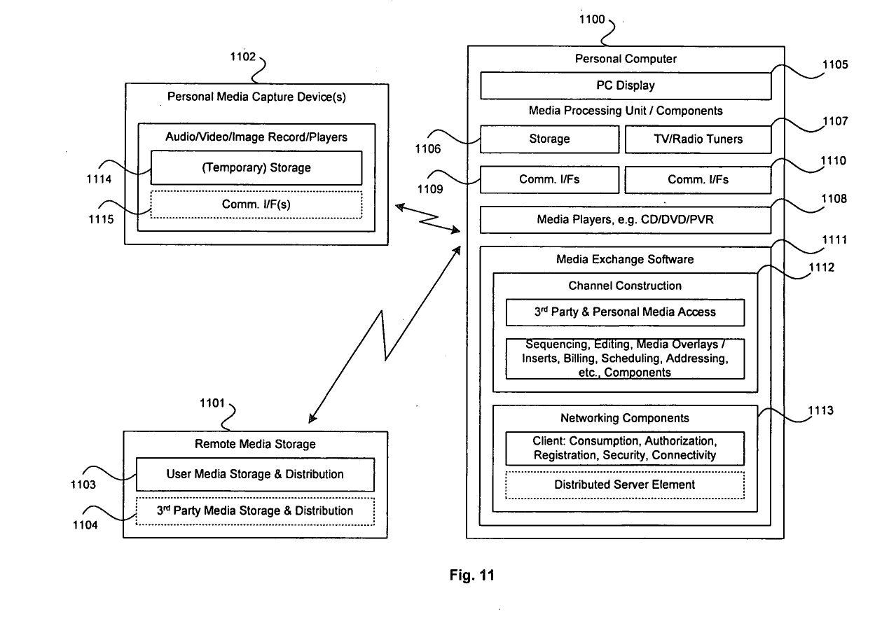

FIG. 11 illustrates connectivity between a PC 1100, remote media storage 1101, and personal media capture devices 1102 when the PC 1100 is used as the primary distributor of digital media such as in the case of PC-to-PC operation, in accordance with an embodiment of the present invention. The personal media capture devices 1102 and remote media storage 1101 connect to the PC 1100 via a wireless or wired connection. The remote media storage 1101 provides user media storage and distribution 1103 as well as third party media storage and distribution 1104. The personal media capture devices 1102 provide temporary storage 1114 and communication interfaces 1115.

Viewing is done using a PC monitor 1105 instead of a television screen. The PC 1100 may include storage 1106, TV/radio tuners 1107 for media consumption, media players 1108, and communication interfaces 1109 and user interfaces 1110 similar to those for the MPS of FIG. 9A. The PC 1100 includes a media exchange software (MES) platform 1111 that provides channel construction capability 1112 and networking capability 1113. The channel construction capability 1112 allows third party and personal media access, sequencing, editing, media overlays and inserts, billing, scheduling, and addressing.

Another embodiment of the invention may provide a system for making information available and accessible in a distributed media network. The system may include at least one processor that may detect the availability of media in a media exchange network. The processor may be adapted to associate at least one media content category with the available media. The processor may also identify at least one media content within the identified media content category. In this regard, the processor may construct a device view and/or a media view for the media. Accordingly, the device view and/or media view may be utilized to make the media available and accessible in the distributed media network.

In another aspect of the invention, the processor may generate the device view from the identified media content category and also generate a media view from the media content category and/or the identified media content. The constructed device view and/or a media view may be formatted by the processor in a graphical user interface. The processor may also be adapted to poll one or more media content providers and/or media storage devices for the available media. Notwithstanding, the media may otherwise be acquired by the processor from a media content provider and/or a media storage device. The processor may also be configured to select at least a portion of the available media, which may be utilized to construct the device view and/or the media view. The processor may be a computer processor, a media peripheral processor, a media exchange system processor, a media processing system processor or a combination thereof.

Accordingly, the present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for presenting available media for selection and playback on a television display, the method comprising:
detecting available media; and
constructing at least one display indicating the availability of said detected available media at a plurality of different storage locations.

2. The method according to claim 1, further comprising presenting an indication of said plurality of different storage locations for said detected available media in said at least one constructed display.

3. The method according to claim 2, wherein said presented indication is at least one of text format, graphic format and audio format.

4. The method according to claim 2, further comprising identifying at least one content category that is associated with said detected available media.

5. The method according to claim 4, further comprising associating said presented indication of said plurality of different storage locations for said detected available media with said at least one content category.

6. The method according to claim 1, further comprising querying one of a provider of media and at least one storage device at said plurality of different storage locations for said available media.

7. The method according to claim 1, further comprising acquiring said available media from at least one of a media content provider and a media storage device.

8. The method according to claim 1, further comprising displaying said constructed at least one display on the television screen.

9. The method according to claim 1, further comprising formatting said constructed at least one display in a graphical user interface.

10. The method according to claim 1, further comprising selecting at least a portion of said detected available media at said plurality of different storage locations for said construction of said at least one display.

11. A machine-readable storage having stored thereon, a computer program having at least one code section for presenting available media for selection and playback on a television display, the at least one code section being executable by a machine for causing the machine to perform steps comprising:
detecting available media; and
constructing at least one display indicating the availability of said detected available media at a plurality of different storage locations.

12. The machine-readable storage according to claim 11, further comprising code for presenting an indication of said plurality of different storage locations for said detected available media in said at least one constructed display.

13. The machine-readable storage according to claim 12, wherein said presented indication is at least one of text format, graphic format and audio format.

14. The machine-readable storage according to claim 12, further comprising code for identifying at least one content category that is associated with said detected available media.

15. The machine-readable storage according to claim 14, further comprising code for associating said presented indication of said plurality of different storage locations for said detected available media with said at least one content category.

16. The machine-readable storage according to claim 11, further comprising code for querying one of a provider of media and at least one storage device at said plurality of different storage locations for said available media.

17. The machine-readable storage according to claim 11, further comprising code for acquiring said available media from at least one of a media content provider and a media storage device.

18. The machine-readable storage according to claim 11, further comprising code for displaying said constructed at least one display on the television screen.

19. The machine-readable storage according to claim 11, further comprising code for formatting said constructed at least one display in a graphical user interface.

20. The machine-readable storage according to claim 11, further comprising code for selecting at least a portion of said detected available media at said plurality of different storage locations for said construction of said at least one display.

21. A system for presenting available media for selection and playback on a television display, the system comprising:
at least one processor that detects available media; and
said at least one processor constructs at least one display indicating the availability of said detected available media at a plurality of different storage locations.

22. The system according to claim 21, wherein said at least one processor presents an indication of said plurality of different storage locations for said detected available media in said at least one constructed display.

23. The system according to claim 22, wherein said presented indication is at least one of text format, graphic format and audio format.

24. The system according to claim 22, wherein said at least one processor identifies at least one content category that is associated with said detected available media.

25. The system according to claim 24, wherein said at least one processor associates said presented indication of said plurality of different storage locations for said detected available media with said at least one content category.

26. The system according to claim 21, wherein said at least one processor queries one of a provider of media and at least one storage device at said plurality of different storage locations for said available media.

27. The system according to claim 21, wherein said at least one processor acquires said available media from at least one of a media content provider and a media storage device.

28. The system according to claim 21, wherein said at least one processor causes said constructed at least one display to be displayed on the television screen.

29. The system according to claim 21, wherein said at least one processor formats said constructed at least one display in a graphical user interface.

30. The system according to claim 21, wherein said at least one processor selects at least a portion of said detected available media at said plurality of different storage locations for said construction of said at least one display.

31. The system according to claim 21, wherein said at least one processor is at least one of a computer processor, a media peripheral processor, a media exchange system processor and a media processing system processor.
